(19) United States
(12) Patent Application Publication
(10) Pub. No.: US 2026/0296260 A1
(43) Pub. Date: Oct. 1, 2026

(54) Battery Contactor and Vehicle Battery System

(71) Applicant: Mercedes-Benz Group AG, Stuttgart (DE)

(72) Inventors: Haocheng SUN, Beijing (CN); Tao HU, Beijing (CN); Xingchen XIAO, Beijing (CN)

(21) Appl. No.: 19/475,714

(22) PCT Filed: Apr. 4, 2024
(86) PCT No.: PCT/EP2024/025145

§ 371 Date: Oct. 15, 2025

(30) Foreign Application Priority Data
Apr. 20, 2023 (CN) 202310430121.9

(51) Int. Cl. B60L 58/10; H01M 10/42; H02J 7/00; H02J 7/62; H02J 7/90; H02J 107/20

(52) U.S. Cl. CPC B60L 58/10; H01M 10/425; H02J 7/62; H02J 7/855; H02J 7/90; H01M 2010/4271; H02J 2107/20; H02J 2207/20

(57) ABSTRACT

A battery connector includes a voltage conversion and stabilization unit, a coupling unit, and a contactor. The contactor is connected to an output end of a power battery via the voltage conversion and stabilization unit and the contactor receives a control signal sent by a battery management system via the coupling unit.

### BACKGROUND AND SUMMARY OF THE INVENTION

The present invention relates to the field of vehicle batteries, and in particular, to a battery connector and a vehicle battery system.

An isolation system of a vehicle power battery includes a battery contactor. The battery contactor has a closed state and an open state, and can be switched between the two states, thereby realizing on and off functions of the power battery. In a current vehicle battery system, the battery contactor and a battery management system are each connected to a 12 V vehicle-mounted power supply circuit and driven by a 12 V low-voltage power supply, and the battery contactor is switched between the closed state and the open state on the basis of a control signal of the battery management system.

However, the output voltage of the low-voltage power supply is particularly susceptible to fluctuations, and the closing time of the battery contactor will also fluctuate accordingly. In particular, when the supply voltage of the low-voltage power supply is too low, the battery contactor may be closed too slowly or even unclosed, causing the vehicle to be unable to start.

In addition, considering that the battery contactor and the battery management system are connected in the same power supply circuit, a large impact current (for example, up to 25 A to 30 A) will be generated when the battery contactor is closed, and this impact current will generate a certain impact on the battery management system, which increases the design difficulty of circuits of the battery management system and the design difficulty of electromagnetic compatibility.

Therefore, how to design a stable and reliable battery contactor has become a technical challenge that needs to be solved currently.

An objective of the present invention is to provide a battery connector and a vehicle battery system to at least partially solve the problems in the prior art.

According to a first aspect of the present invention, a battery connector is provided. The battery connector may comprise a voltage conversion and stabilization unit, a coupling unit, and a contactor, wherein the contactor is connected to an output end of a power battery via the voltage conversion and stabilization unit, and the contactor receives a control signal sent by a battery management system via the coupling unit.

The core concept of the present invention is as follows: the contactor is connected in a high-voltage power supply circuit of the power battery, and the control signal of the battery management system in a low-voltage power supply circuit is received by means of the coupling unit, thereby realizing switching between on and off states of the contactor. According to a current embodiment of the present invention, on the one hand, the contactor may acquire a stable, particularly less fluctuating, driving voltage from a high-voltage output end of the power battery, thereby enhancing the robustness of the contactor. On the other hand, the battery management system for generating the control signal is configured in the low-voltage power supply circuit separately from the contactor, so that the battery management system no longer needs to supply power to the contactor. The operating voltage and operating current required by the battery management system are both significantly reduced while avoiding the influence of an impact current generated by the closing of the contactor on the battery management system, enhancing the operational stability of the battery management system, and improving the electromagnetic compatibility of the vehicle power system.

According to an optional embodiment of the present invention, the coupler may comprise a transmitter and a receiver, the transmitter is configured to convert a first electrical control signal sent by the battery management system to a non-electrical signal and transmit the same, and the receiver is configured to convert the received non-electrical signal to a second electrical control signal for controlling the contactor. Here, the coupling of the low-voltage power supply circuit to the high-voltage power supply circuit can be realized by means of the signal conversion by the transmitter and the receiver.

According to another optional embodiment of the present invention, the coupler may be configured as a photoelectric coupler, wherein the non-electrical signal may comprise an optical signal. Optionally, the photoelectric coupler may comprise a light-emitting diode serving as the transmitter and a phototransistor serving as the receiver.

According to another optional embodiment of the present invention, the coupler may be configured as an acoustoelectric coupler, wherein the non-electrical signal may comprise an acoustic signal. Optionally, the acoustoelectric coupler may comprise a buzzer serving as the transmitter and an acoustic sensor serving as the receiver.

According to another optional embodiment of the present invention, an output voltage of the power battery may be converted and stabilized within a rated operating voltage range of the contactor by means of the voltage conversion and stabilization unit.

According to another optional embodiment of the present invention, the voltage conversion and stabilization unit may comprise a voltage stabilization diode, a transistor, and a current limiting resistor, wherein the current limiting resistor may be configured to be a bias resistor of the transistor and is used to limit a current flowing through the voltage stabilization diode, and the voltage stabilization diode may be configured to clamp a base voltage of the transistor.

According to another optional embodiment of the present invention, the voltage conversion and stabilization unit may be configured as a BUCK circuit.

According to a second aspect of the present invention, a vehicle battery system is provided. The vehicle battery system comprises a power battery, a battery management system, and the battery connector according to the present invention.

The principles, features, and advantages of the present invention can be better understood via further detailed description of the present invention with reference to the accompanying drawings.

### BRIEF DESCRIPTION OF THE DRAWINGS

FIG. 1 shows a schematic structural diagram of a battery connector according to an exemplary embodiment of the present invention;

FIG. 2 shows a schematic structural diagram of a battery connector according to another exemplary embodiment of the present invention;

FIG. 3 shows a schematic structural diagram of a battery connector according to another exemplary embodiment of the present invention; and

FIG. 4 shows a schematic structural diagram of a battery connector according to another exemplary embodiment of the present invention.

### DETAILED DESCRIPTION OF THE DRAWINGS

In order to make the technical problems to be solved by the present invention, the technical solutions, and the beneficial technical effects clearer, the present invention will be described below in further detail with reference to the accompanying drawings and a plurality of exemplary embodiments. It should be understood that the specific embodiments described herein are merely used to explain the present invention, but are not used to limit the scope of protection of the present invention.

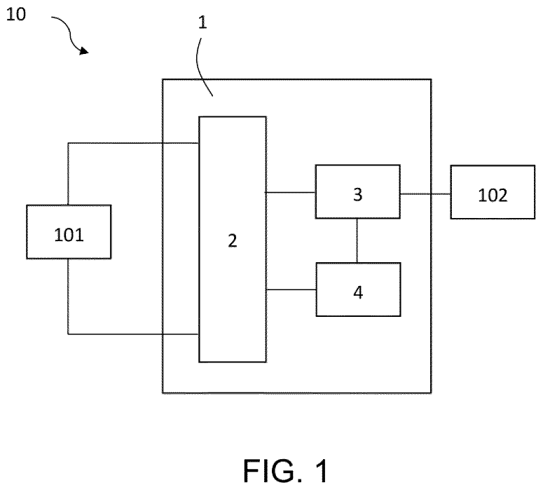

FIG. 1 shows a schematic structural diagram of a battery connector according to an exemplary embodiment of the present invention. The battery connector according to the present invention will be described in further detail in the following exemplary embodiments.

As shown in FIG. 1, a vehicle battery system 10 may include a battery connector 1, a power battery 101, and a battery management system 102. The power battery 101 may be configured as a rechargeable high-voltage battery for energy supply of voltage components, for example, a high-voltage battery of 400 V or a higher voltage. The battery management system 102 is used to control the operating state of the battery connector 1.

Here, the battery connector 1 may include a voltage conversion and stabilization unit 2, a contactor 4, and a coupling unit 3. The voltage conversion and stabilization unit 2 may be connected at an output end of the power battery 101, especially between a positive electrode and a negative electrode of the power battery 101.

The contactor 4 may be connected to the power battery 101 via the voltage conversion and stabilization unit 2, and obtain energy supply from the power battery 101 via the voltage conversion and stabilization unit 2. The voltage conversion and stabilization unit 2 can convert, especially step down, a direct-current output voltage (for example, a high output voltage of 400 V) of the power battery 101, and stabilize the converted voltage within a rated operating voltage range of the contactor 4. The rated operating voltage of the contactor 4 is typically 12 V. It should be noted that the voltage conversion and stabilization unit 2 may include a voltage conversion module and a voltage stabilization module that are configured separately, wherein the voltage conversion module is used to convert, especially step down, the output voltage of the power battery 101 into a desired output voltage, and the voltage stabilization module is used to stably maintain the converted voltage at the desired output voltage, especially within the rated operating voltage range of the contactor 4. The voltage conversion and stabilization unit 2 may also include an integrally structured voltage conversion and stabilization module that can realize both voltage conversion and voltage stabilization functions.

It should be noted that in the current embodiment of the present invention, the contactor 4 is a contactor with positive and negative electrodes integrated into one body, and simultaneously connects to the positive and negative electrodes of a direct-current input voltage. When using a single-positive or single-negative contactor, it is necessary to provide a power acquisition point for the other electrode of the contactor.

The contactor 4 may receive a control signal sent by a battery management system 6 via the coupler 3. Here, the coupler 3 may include a transmitter 31 and a receiver 32. The transmitter 31 may be configured to convert a first electrical control signal sent by the battery management system 102 to a non-electrical signal and transmit the converted non-electrical signal. The first electrical control signal may include, in particular, a closing signal and/or an opening signal of the contactor, and the non-electrical signal obtained by the conversion may include, for example, an optical signal, an acoustic signal, and/or a magnetic signal, etc. The receiver 32 may be configured to convert the received non-electrical signal into a second electrical control signal for controlling the contactor 4, so as to correspondingly realize switching between a closed state and an open state of the contactor 4 based on instructions of the battery management system 102.

Here, the transmitter 31 and the battery management system 102 are connected in a low-voltage power supply circuit of, for example, 12 V, and the receiver 32 and the contactor 4 are connected in a high-voltage power supply circuit powered by the power battery 101. The coupling of the low-voltage power supply circuit to the high-voltage power supply circuit can be realized by means of signal conversion by the transmitter 31 and the receiver 32.

According to the current embodiment of the present invention, on the one hand, the contactor 4 may acquire a stable, particularly less fluctuating, driving voltage from the high-voltage output end of the power battery 101, thereby enhancing the robustness of the contactor 4. On the other hand, the battery management system 102 for generating the control signal is configured in the low-voltage power supply circuit separately from the contactor 4, so that the battery management system 102 no longer needs to supply power to the contactor 4, but only needs to supply power to the transmitter 31 of the coupler 3. The operating voltage and operating current required by the battery management system 102 are both significantly reduced while avoiding the influence of an impact current generated by the closing of the contactor 4 on the battery management system 102, enhancing the operational stability of the battery management system 102, and improving the electromagnetic compatibility of the vehicle power system 10.

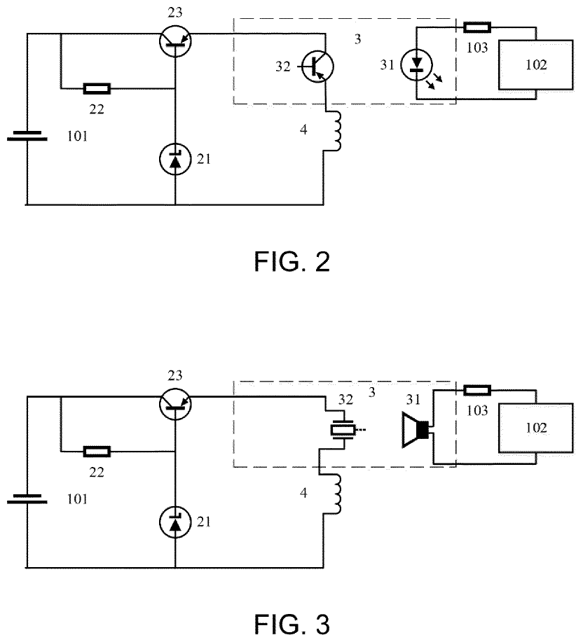

FIG. 2 shows a schematic structural diagram of a battery connector according to another exemplary embodiment of the present invention. Only the differences from the embodiment shown in FIG. 1 will be described below, and for the sake of brevity, the same components will not be described again.

In an optional embodiment of the present invention, the voltage conversion and stabilization unit 2 connected in the high-voltage power supply circuit powered by the power battery 101 may include a voltage stabilization diode 21, a transistor 23, and a current limiting resistor 22. Here, the current limiting resistor 22 is connected between a base and a collector of the transistor 23. The current limiting resistor 22 may function as a bias resistor for the transistor 23, and is used to adjust the magnitude of a base bias current of the transistor 23. A positive electrode of the voltage stabilization diode 21 is connected to the positive electrode of the power battery 101, and a negative electrode of the voltage stabilization diode 21 is connected to the base of the transistor 23, so as to clamp a base voltage of the transistor 23 so that the transistor 23 operates in a linear region. Considering that the direct-current output voltage of the power battery 101 is very high, for example, up to 400 V or higher, the current limiting resistor 22 may also limit the current flowing through the voltage stabilization diode 21, thereby preventing diode breakdown caused by excessive current flowing through the voltage stabilization diode 21.

Optionally, a rated operating voltage of the voltage stabilization diode 21 may be selected to be 13 V, so that the base voltage of the transistor 23 may be clamped at 13 V. When the transistor 23 is, for example, a silicon transistor, in view of a voltage drop of 0.7 V between the base and an emitter of the transistor 23, an emitter voltage output by the transistor 23 will be stably maintained within a voltage range of 12.3 V, which is within the rated operating voltage range of the contactor 4.

Optionally, the coupler 3 may be configured as a photoelectric coupler 301, including, for example, a light-emitting diode serving as the transmitter 31 and a phototransistor serving as the receiver 32. Here, the light-emitting diode 31 and the battery management system 102 are jointly connected in a low-voltage power supply circuit of 12 V. Optionally, a current limiting resistor 103 may be further connected in the low-voltage power supply circuit to prevent the occurrence of excessive current in the low-voltage power supply circuit. The phototransistor 32 is connected in a high-voltage power supply circuit powered by the power battery 101, wherein a collector of the phototransistor 32 is connected to the emitter of the transistor 23, and an emitter of the phototransistor 32 is connected to the contactor 4, so that the emitter voltage of 12.3 V or so output by the transistor 23 will be applied to the contactor 4 and the phototransistor 32, thereby enabling the contactor 4 to operate within the rated operating voltage range.

Here, the light-emitting diode 31 and the phototransistor 32 may realize the coupling of the high-voltage power supply circuit to the low-voltage power supply circuit by conversion between optical signals and electrical signals. Here, the first electrical control signal sent by the battery management system 102 may control the light-emitting state of the light-emitting diode 31, and the phototransistor 32 may switch the closed state and the open state of the contactor 4 on the basis of the light-emitting state of the light-emitting diode 31. Illustratively, when the battery management system 102 stops supplying power, the light-emitting diode 31 will stop emitting light, and the phototransistor 32 enters a cut-off region due to not receiving an optical signal, thereby turning off the high-voltage power supply circuit, and causing the contactor 4 to be in the open state. When the battery management system 102 sends the first electrical control signal for closing the contactor 4, the light-emitting diode 31 will perform forward conduction and emit light on the basis of the received first electrical control signal. After an optical signal emitted by the light-emitting diode 31 is irradiated to the base of the phototransistor 32, the phototransistor 32 is turned on, thereby switching the contactor 4 in the high-voltage power supply circuit to the closed state. After the contactor 4 is closed, the high-voltage power supply circuit is turned on, so that the emitter voltage of, for example, 12.3 V, output by the transistor 23 will be applied to the contactor 4, thereby stably maintaining the closed state of the contactor 4.

FIG. 3 shows a schematic structural diagram of a battery connector according to another exemplary embodiment of the present invention. Only the differences from the embodiment shown in FIG. 2 will be described below, and for the sake of brevity, the same components will not be described again.

In another optional embodiment of the present invention, the coupler 3 may be configured as an acoustoelectric coupler 302, including, for example, a buzzer 31 serving as the transmitter and an acoustic sensor 32 serving as the receiver. Here, the buzzer 31 and the battery management system 102 are jointly connected in a low-voltage power supply circuit of 12 V, and a sound producing state and a silent state of the buzzer 31 are controlled by the battery management system 102. The acoustic sensor 32 may be connected in a high-voltage power supply circuit powered by the power battery 101 to switch the closed state and the open state of the contactor 4 according to an identified acoustic signal. Illustratively, when the battery management system 102 stops supplying power, the buzzer 31 is set in the silent state, and the acoustic sensor 32 enters an off state when no acoustic signal is identified, thereby switching the contactor 4 in the high-voltage power supply circuit to the open state. When the battery management system 102 sends the first electrical control signal for closing the contactor 4, the buzzer 31 will emit an acoustic signal having a preset frequency, and the acoustic sensor 32 enters an on state after receiving the acoustic signal, thereby switching the contactor 4 in the high-voltage power supply circuit to the closed state. After the contactor 4 is closed, the high-voltage power supply circuit is turned on, so that an emitter voltage of, for example, 12.3 V, output by the transistor 23 will be applied to the contactor 4, thereby stably maintaining the closed state of the contactor 4.

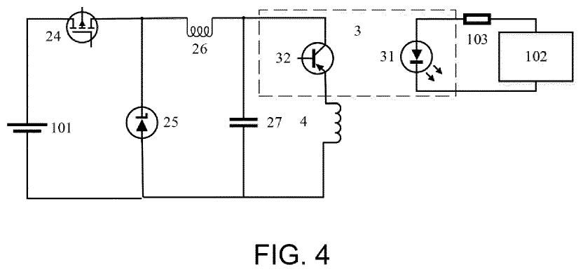

FIG. 4 shows a schematic structural diagram of a battery connector according to another exemplary embodiment of the present invention. Only the differences from the embodiment shown in FIG. 2 will be described below, and for the sake of brevity, the same components will not be described again.

In another optional embodiment of the present invention, the voltage conversion and stabilization unit 2 may be configured as a BUCK circuit, which may include, for example, a switching transistor 24, a free-wheeling diode 25, an inductor 26, and a capacitor 27. Here, on and off of the switching transistor 24 is driven by a PWM driving signal to chop a direct-current voltage output by the power battery 101. Illustratively, when the PWM driving signal is at a high level, the switching transistor 24 is turned on, and a current continuously flows through the inductor 26 and charges the capacitor 27. When the PWM driving signal is at a low level, the switching transistor 24 is turned off, and a freewheeling current in the inductor 26 can flow through the free-wheeling diode 25 and linearly decrease. Meanwhile, the output direct-current voltage can be filtered by means of a low-pass filter consisting of the inductor 26 and the capacitor 27. In this way, the direct-current input voltage of the power battery 101 can be converted to a desired direct-current output voltage by the BUCK circuit, so that the contactor 4 is within the rated operating voltage range, wherein the desired direct-current output voltage may be adjusted by means of the duty cycle of the PWM signal. Here, in particular, the switching transistor 24 may be driven by a high-frequency PWM driving signal to turn on and off at high speed to achieve the purpose of voltage stabilization.

It should be noted that although specific implementations of the present invention are described in detail herein, they are merely for the purpose of explanation, and should not be considered as limiting the scope of the present invention. Various replacement schemes and modification schemes may be provided as long as the schemes do not depart from the core and scope of the present invention.

1.-10. (canceled)

11. A battery connector (1), comprising:
a voltage conversion and stabilization unit (2);
a coupling unit (3); and
a contactor (4), wherein the contactor (4) is connected to an output end of a power battery (101) via the voltage conversion and stabilization unit (2) and wherein the contactor (4) receives a control signal sent by a battery management system (102) via the coupling unit (3).

12. The battery connector (1) according to claim 11, wherein the coupling unit (3) comprises a transmitter (31) and a receiver (32), wherein the transmitter (31) is configured to convert a first electrical control signal sent by the battery management system (102) to a non-electrical signal and transmit the non-electrical signal, and wherein the receiver (32) is configured to convert a received non-electrical signal to a second electrical control signal for controlling the contactor (4).

13. The battery connector (1) according to claim 12, wherein the coupling unit (3) is configured as a photoelectric coupler (301) and wherein the non-electrical signal comprises an optical signal.

14. The battery connector (1) according to claim 13, wherein the photoelectric coupler (301) comprises a light-emitting diode serving as the transmitter (31) and a phototransistor serving as the receiver (32).

15. The battery connector (1) according to claim 12, wherein the coupling unit (3) is configured as an acoustoelectric coupler (302) and wherein the non-electrical signal comprises an acoustic signal.

16. The battery connector (1) according to claim 15, wherein the acoustoelectric coupler (302) comprises a buzzer serving as the transmitter (31) and an acoustic sensor serving as the receiver (32).

17. The battery connector (1) according to claim 11, wherein an output voltage of the power battery (101) is converted and stabilized within a rated operating voltage range of the contactor (4) by the voltage conversion and stabilization unit (2).

18. The battery connector (1) according to claim 17, wherein the voltage conversion and stabilization unit (2) comprises a voltage stabilization diode (21), a transistor (23), and a current limiting resistor (22), wherein the current limiting resistor (22) is configured to be a bias resistor of the transistor (23) and is used to limit a current flowing through the voltage stabilization diode (21), and wherein the voltage stabilization diode (21) is configured to clamp a base voltage of the transistor (23).

19. The battery connector (1) according to claim 17, wherein the voltage conversion and stabilization unit (2) is configured as a BUCK circuit.

20. A vehicle battery system (10), comprising:
a power battery (101);
a battery management system (102); and
the battery connector (1) according to claim 11.
